(19) United States
(12) Patent Application Publication
(10) Pub. No.: US 2025/0144581 A1
(43) Pub. Date: May 8, 2025

(54) MIXING SYSTEM

(71) Applicant: CASALE SA, Lugano (CH)

(72) Inventors: Andrea BERETTI, Rovellasca (CO) (IT); Iacopo CEREA, Lugano (CH)

(21) Appl. No.: 18/730,444

(22) PCT Filed: Jan. 20, 2023
(86) PCT No.: PCT/EP2023/051343

§ 371 Date: Jul. 19, 2024

(30) Foreign Application Priority Data
Jan. 26, 2022 (EP) 22153467.0

(51) Int. Cl. B01F 25/313; B01D 53/14; B01D 53/18; B01D 53/86; B01F 23/10; B01F 25/40; B01J 4/00; B01J 10/00; C01B 21/40

(52) U.S. Cl. CPC B01F 25/31332; B01D 53/1456; B01D 53/18; B01D 53/8631; B01F 23/10; B01F 25/3131; B01F 25/31331; B01F 25/40; B01J 4/008; B01J 10/002; C01B 21/40; B01D 2251/2062; B01D 2252/103; B01D 2257/404; B01D 2258/0283; B01D 2259/10; B01J 2204/002

(57) ABSTRACT

A mixing system configured to mix a process gas into a mainstream to be processed, the mixing system comprises a distribution channel, an injection unit and a static mixing unit; the injection unit comprises a manifold and a main injection ring, the manifold is adapted to receive said fluid or gas to be injected into the mainstream via said main injection ring, said main injection ring has a circular or annular structure and is provided with a plurality of injection orifices for introducing said process gas into the mainstream.

### FIELD OF APPLICATION

The invention is in the field of mixing devices configured to inject a process gas into a main flow to be processed. More particularly, the invention relates to a mixing system adapted for use in a system for selective catalytic reduction of NOx contained in a flue gas, such as the tail gas of a nitric acid plant.

### PRIOR ART

Mixing devices are present in all the apparatus requiring the mixing between multiple streams for example in combustion units, in catalytic synthesis converters and in catalytic purification units.

In a catalytic purification unit, a gas or a fluid containing contaminants is mixed prior to entering a catalytic bed with a reducing agent to promote the conversion of the contaminants into non-harmful species.

Selective catalytic reduction (SCR) is widely used for processing flue gas (e.g. from a combustion process) and for converting nitrogen oxides into non-harmful nitrogen and water. For this purpose, a reducing agent e.g. ammonia or urea is continuously injected into the NOx-containing gas to be processed. The term nitrogen oxides refers typically to NO and NO2.

An application of considerable industrial interest is represented by deNOx reactors of nitric acid plants. The industrial production of nitric acid is based on the Ostwald process, wherein a NOx-containing gas, obtained by oxidation of ammonia, is contacted with water in a suitable absorption column, so that NOx are absorbed in water to produce nitric acid. A tail gas containing residual NOx and possibly nitrous oxide N20 is removed from the absorption tower and must be treated to reduce the NOx content to an acceptable level, such as 100 ppm or less. To this purpose, a suitable deNOx reactor must be arranged downstream the absorption column.

Conventional SCR mixing systems arranged in deNOx reactors comprise a conduct, an injection unit and a static mixer arranged downstream of the injection unit. The injection unit includes a cylindrical bore manifold configured to feed the reducing agent into the mainstream of tail gas whilst the static mixer comprises a honeycomb structure configured to promote the mixing between ammonia and tail gas.

Unfortunately, the above-mentioned mixing devices cannot achieve a high mixing efficiency in a wide range of flow rates injected. In particular, when the flow rate of the injected reducing agent (e.g. ammonia) is orders of magnitude smaller than the flow rate of the gas to be processed (e.g. tail gas), a low mixing efficiency is likely to occur.

Consequently, to achieve a satisfactory mixing efficiency and a homogenous mixture, the mixing system must be contained in very long channels or conduits. Unfortunately, this solution is not always feasible in nitric acid plants especially when operations of revamping or modernization of pre-existing plants are carried out because, quite often, the physical space available to carry out this operation is limited.

A low mixing efficiency between the tail gas containing nitrogen oxides and the reducing agent may result in the slip of ammonia across the catalytic bed, particularly when ammonia is dosed in excess, or to a low conversion of NOx particularly when ammonia is underdosed. Furthermore, a low mixing efficiency can also result in an uneven temperature distribution across the catalytic bed due to the exothermic nature of the SCR reaction. Said uneven temperature distribution can further affect the conversion of NOx into nitrogen and water and can also cause uneven wearing of the catalyst potentially leading to a loss of catalyst.

In light of the consideration stated above, it is evident how important is to establish homogenous mixing conditions between the tail gas and the reducing agent in a deNOx reactor. Therefore, it is particularly desirable to provide a mixing device that can guarantee a high mixing efficiency over a wide range of flow rates injected and over a short length of the distribution channel.

Devices suitable to inject a reducing agent in an exhaust gas stream of a combustion engine, for use in the automotive field, are disclosed in U.S. Pat. No. 10,392,989 and DE 10 2011 078 181. An in-line mixing apparatus for gases is described in U.S. Pat. No. 3,702,619.

### SUMMARY OF THE INVENTION

The invention aims to overcome the above drawbacks of the prior art related to the low mixing efficiency of the conventional mixing devices. The invention aims to provide a novel mixing system which is particularly suitable to mix a process gas into a main stream, when the flow rate of the process gas is considerably smaller than the flow rate of the mainstream. More specifically the invention aims to provide a mixing system particularly suitable for use in reactors for selective catalytic reduction of nitrogen oxides from a gas, wherein said process gas is a reducing agent for the reduction of nitrogen oxides.

The above aims are reached with a mixing system according to the claims.

The mixing system comprises an injection unit, a static mixing unit and a distribution channel that has a main longitudinal axis which, in operation, determines the flow direction of the mainstream.

The injection unit comprises a manifold and a main injection ring, the manifold is arranged inside the distribution channel and is disposed perpendicularly to the main longitudinal axis of said distribution channel. The manifold is adapted to receive the process gas via said main injection ring; said main injection ring has a circular or annular structure and is provided with a plurality of injection orifices that are arranged to introduce the process gas into the flow direction of the mainstream.

An interesting application of the invention is to use the inventive mixing system in a reactor for the removal of NOx from a gas stream (de-NOx reactor). A deNOx reactor contains a catalyst suitable for catalytic reduction of nitrogen oxides in the presence of the reducing agent. Such catalysts are known in the art and include, among others, iron-loaded zeolite catalysts. The reducing agent used in deNOx reactors preferably is ammonia or contains ammonia.

Hence an aspect of the invention is a conditioning system for removing nitrogen oxides from an input gas by means of selective catalytic reduction, the conditioning system including a catalytic reactor and the inventive mixing system, the reactor being configured to catalytically reduce NOx contained in the input gas in presence a reducing agent, the mixing system being configured so that the mainstream is the input gas directed to the reactor and the process gas is the reducing agent.

In a particularly interesting application of the invention, said conditioning system is part of a nitric acid synthesis plant and more particularly of a stage for conditioning a NOx-containing tail gas before it is discharged to a stack. Said tail gas is commonly withdrawn from an absorption column where nitric acid is produced.

Said conditioning system may include more than one catalytic reactor. In some embodiments, the conditioning system may include a first reactor for removal of N20 followed by a second reactor for removal of NOx. In such a case, the mixing system for introduction of the reducing agent is preferably arranged downstream the first reactor and upstream the second reactor, to add the reducing agent to the effluent of the first reactor before it enters the second reactor.

The invention further relates to a nitric acid plant including an absorption column and the above mentioned conditioning system, wherein in the absorption column a NOx-containing gas is absorbed into water for production of nitric acid and a tail gas containing residual NOx is withdrawn from the column, wherein the manifold of the mixing system is connected to a feed line of the reducing agent, which is preferably ammonia, and the distribution conduct of the mixing system is connected to a tail gas output of said absorption column.

The mixing system of the present invention allows to achieve a high mixing efficiency when the flow rate of reducing agent is considerably lower than the flow rate of the gas to be processed. Advantageously, the high mixing efficiency established in the mixing system enables a high conversion of the NOx contained in the tail gas and allows an even temperature distribution over the catalytic bed.

Furthermore, a high mixing efficacy can be achieved over a very short distance of the mixing devices making the device suitable for revamping operation. Particularly the invention may be useful to revamp and modernize nitric acid plants in order to meet more stringent limits in terms of NOx emissions.

### DETAILED DESCRIPTION OF THE INVENTION

The mixing system of the invention is particularly suited to injecting a small quantity of a process gas into a mainstream of a gas to be processed. The process gas may be selected to perform a desired conditioning of the main stream, such as the catalytic removal of contaminants or pollutants.

The present invention can be used in particular to inject a reducing agent for treating a mainstream gas in a selective catalytic reduction process for removal of contaminants. A particularly preferred application is removal of nitrogen oxides NOx from a flue gas, wherein the process gas is preferably ammonia. Accordingly, the mixing system of the invention is used to mix the reducing agent, such as ammonia, into a NOx-containing gas to be processed, to cause the reduction of the NOx to N2 and H20 over a suitable catalyst.

The mixing system of the present invention can be arranged inside a purification reactor and above a catalytic bed. For instance, the mixing system of the present invention can be arranged inside a deNOx reactor of a nitric acid plant for removing nitrogen oxides from a tail gas exiting an absorption column.

Particularly interesting results were found in the embodiments of processing a NOx-containing gas, particularly a tail gas obtained from production of nitric acid, with ammonia as reducing agent, when the mass ratio between the ammonia and the tail gas fed to the mixing system is not greater than 1 to 1000, preferably not greater than 1 to 5000 and more preferably in the range 1 to 5000 to 1 to 7000,for example 1 to 6500.

In the mixing system, the injection unit is preferably arranged above the static mixing unit and said injection unit and said static mixing unit are preferably arranged inside a conduct. The conduct is preferably circular and has a main longitudinal axis which, in operation, determines the flow direction of the mainstream.

The orientation of the injection orifices of the main injection ring determines the direction of injection of the fluid or gas into the mainstream. According to a preferred but not limiting embodiment, the orientation of said orifices is such that the fluid or gas injected by the orifices has the same direction or substantially the same direction as the mainstream. In some embodiments the orientation of the orifices is such that the flow emitted by the orifices is parallel to the main longitudinal axis of the distribution conduct, or form a small angle with said longitudinal axis.

According to an interesting application of the present invention, the mixing system comprises, in addition to the main injection ring, a plurality of additional rings. Preferably said additional rings are in the number of one or two and are arranged concentrically to said main injection ring.

Preferably, the addition ring/s is/are in fluid communication with said manifold by means of one or more additional manifold/s arranged to allow the passage of said fluid or gas from one ring to another.

Said one or more additional ring/s is/are provided with a plurality of injection orifices arranged to introduce the process gas into the mainstream. Accordingly, the fluid or gas stream is injected into the mainstream with the same direction of the latter. Accordingly, in some embodiments, a first portion of the process gas is introduced by a first set of orifices arranged on the main injection ring and a second portion of the process gas is introduced via orifices of one or more additional injection ring(s).

The injection orifices of the main injection ring and the injection orifices of any additional rings, if provided, may be oriented in the flow direction of the mainstream. According to embodiments, said orifices may be oriented parallel to said longitudinal axis, or forming a small angle with said axis. Said angle is preferably not greater than 30° or more preferably not greater than 10°. An injection of the process gas according to the flow direction of the mainstream facilitates the dispersion of the process gas into the mainstream.

According to an embodiment of the invention, said main ring and said one or more additional ring/s lie in a plane that is perpendicular to the main longitudinal axis of the distribution conduct. Preferably, said main injection ring and said one or more additional ring/s are equally spaced between each other.

Preferably, said main injecting ring and/or said one or more additional ring/s is/are integral with said distribution channel by means of one or more supports. Said one or more support/s can be fastened or welded on said distribution channel.

According to an embodiment of the invention, the injection unit further comprises an injection tube that extends longitudinally from the manifold. The injection tube can be provided with a plurality of metering openings. The metering openings can be disposed lengthwise along the length of said injection tube and can be oriented in the flow direction of the mainstream. Also the metering openings of said injection tube may be oriented parallel to or forming a small angle with the longitudinal axis of the conduct.

According to another embodiment of the invention, the injection unit further comprises an injection conduct, said injection conduct extends longitudinally from said manifold and is provided with a plurality of injection tubes. The injection tubes are disposed lengthwise forming at least one row along the length of the injection conduct.

The injection tubes can be parallel to each other and can be arranged so that for each row of tubes, each pair of consecutive tubes is made of two tubes of different length.

Preferably, each injection tube is provided with an aperture configured to eject said fluid or gas with a flow direction perpendicular to the main longitudinal axis of the distribution channel.

According to an interesting application of the invention, the number of rows is two and said two rows are arranged on the opposite sides of the injection conduct.

According to a particularly interesting application of the present invention, the mixing system is used for removing NOx from the tail gas of a nitric acid production process; the manifold is connected to an ammonia feed and said distribution conduct is connected to the tail gas output line of an absorption column, so that said fluid or gas is an ammonia feed and said mainstream is a tail gas containing NOx.

The dimension of the diameter of the injection rings and of the injection orifices can be optimised by the skilled person depending on the flow rate of gas or liquid circulating in the manifold, depending on the flow rate of mainstream entering the mixing devices and depending on the injection velocity required to establish a high mixing efficiency in the mixing system. Preferably, all the additional rings have the same diameter as the main ring and preferably the diameter of each ring is comprised between 20 to 30 mm.

Preferably, the number of injection orifices arranged on said main injection ring is comprised between 8 to 20, more preferably between 10 to 15.

Preferably, the number of injection orifices arranged on each of said one or more additional ring/s is comprised between 3 to 15, more preferably between 4 to 8.

Preferably, the number of injection tubes arranged on said injection conduct is comprised between 5 and 20, more preferably between 8 and 16.

According to a particularly preferred embodiment, the injection unit is symmetrical along an axis that is perpendicular to the main longitudinal axis of said distribution channel.

The cross section of said main injection ring and the cross section of any additional ring, if provided, may be a circular cross section or a non-circular cross section, according to different embodiments. In an embodiment, the main ring or any additional ring may have a non-circular cross section with a convex side facing the flow direction of the mainstream. Particularly preferably, such cross section is a semicircular cross section. Said semicircular cross section may include a semicircular side facing the flow direction of the mainstream and a flat side wherein the injection orifices are arranged on the flat side.

The applicant has found that a non-circular cross section of an injection ring provides a particularly effective mixing. It is believed that the improved mixing is caused by the formation of a pattern of vortices around the injection ring, arguably a von Karman vortex street. This pattern of vortices enhances the mixing between the main stream and the injected medium, such as gas and ammonia.

In embodiments with a plurality of injection rings, for example coaxial injection rings, the above-described feature of non-circular cross section may be applied to one, some or all rings.

In embodiments wherein the ammonia gas is fed to two or more items, such as a main ring and an additional ring, a suitable ammonia gas distributor can be provided.

### DESCRIPTION OF THE FIGURES

FIG. 1 shows a conventional mixing system according to a typical prior art configuration.

FIG. 2 shows a cross-sectional view of the injecting unit according to an embodiment of the invention.

FIG. 3 shows a cross-sectional view of the injecting unit according to a preferred embodiment of the invention.

FIG. 4 shows a cross-sectional view of the injecting unit according to an alternative embodiment of the invention.

FIG. 5 shows a cross-sectional view of the injecting unit according to an alternative embodiment of the invention.

FIG. 6 illustrates a cross section of an injection ring according to an embodiment.

FIG. 7 illustrates a detail of FIG. 3.

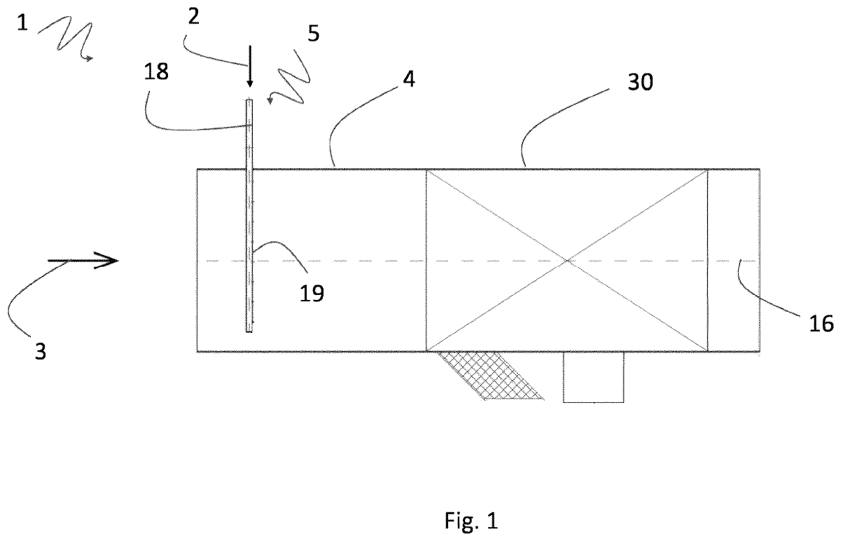

FIG. 1 illustrates a conventional mixing system according to a typical prior art configuration. The mixing system 1 comprises a distribution channel/conduct 4, an injecting unit 5 and a static mixing unit 30 arranged downstream of the injection unit 5. The distribution conduct 4 is circular and is provided with a main longitudinal axis 16.

The injection unit further comprises a cylindrical bore manifold 18 configured to feed ammonia 2, as a reducing agent, into a mainstream 3 of tail gas via a plurality of apertures 19. The ammonia 2 is preferably gaseous ammonia. The static mixing unit 30 comprises a honeycomb structure that is configure to promote the mixing between the reducing agent 2 and the tail gas 3.

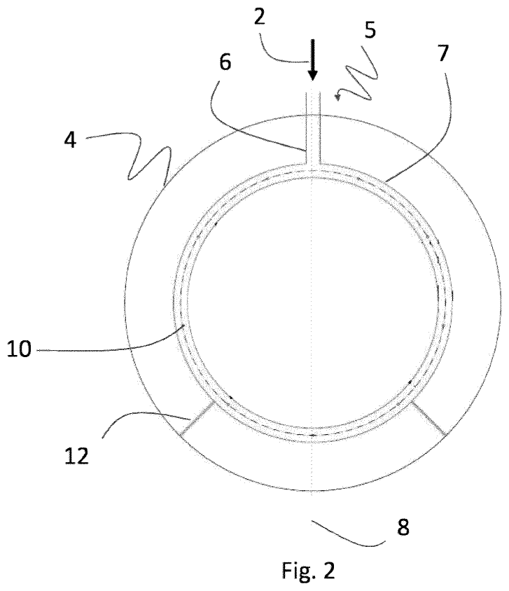

FIG. 2 shows cross-sectional view of the injecting unit 5 according to an embodiment of the invention.

The injection unit 5 comprises a manifold 6 and a main injection ring 7. The manifold 6 is arranged inside the distribution channel 4 and is disposed perpendicularly to the main longitudinal axis 16 of the distribution channel 4 shown in FIG. 1.

The manifold is supplied with ammonia 2 to be injected into the tail gas mainstream 3 via said main injection ring 7.

The injection ring 7 has a circular structure and is provided with a plurality of injection orifices 10 that are oriented in the flow direction of the mainstream 3 so that the ammonia gas 2 is injected into the tail gas 3 having the same or substantially the same flow direction of the latter.

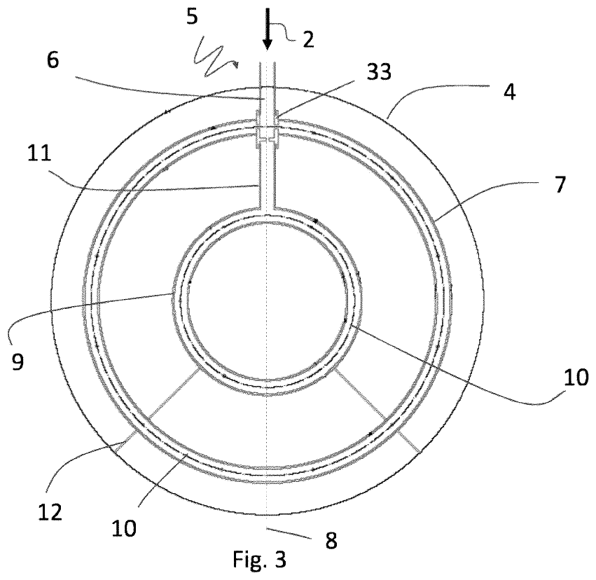

FIG. 3 shows a cross-sectional view of the injecting unit 5 according to a preferred embodiment of the invention.

The injection unit 5 comprises a main injection ring 7 and an additional injection ring 9. The additional injection ring 9 is connected to the main injection ring 7 with a manifold 11, the latter is fastened to the main injection ring 7.

The main injection ring 7 and the additional injection ring 9 are supplied with ammonia gas 2. Each of the rings 7, 9 is provided with a plurality of injection orifice 10 that are preferably oriented in the same direction of the main longitudinal axis 16 of the distribution conduct. Accordingly, said ammonia gas 2 is injected into the mainstream 3 having the same or substantially the same flow direction of the latter.

The ammonia gas 2 is distributed between the main ring 7 and the additional ring 9 by means of a distributor 33 which is further described below with reference to FIG. 7.

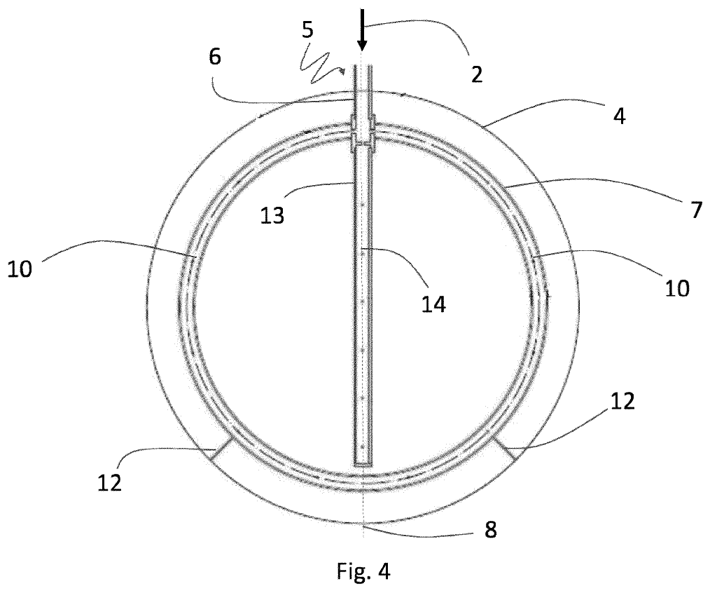

FIG. 4 shows a cross-sectional view of the injecting unit 5 according to an alternative embodiment of the invention.

The injection unit 5 comprises a main injection ring 7 and injection tube 13. The injection tube 13 is fastened to the main injection ring 7 and extends longitudinally from said manifold 6.

The injection tube 13 is provided with a plurality of metering openings 14 disposed lengthwise along the length of said injection tube 13.

Like the above-described orifices 10, the metering openings 14 are preferably oriented in the flow direction of the main longitudinal axis 16 of said distribution conduct 4 so to inject said ammonia reducing agent 2 with the same flow direction of the tail gas 3.

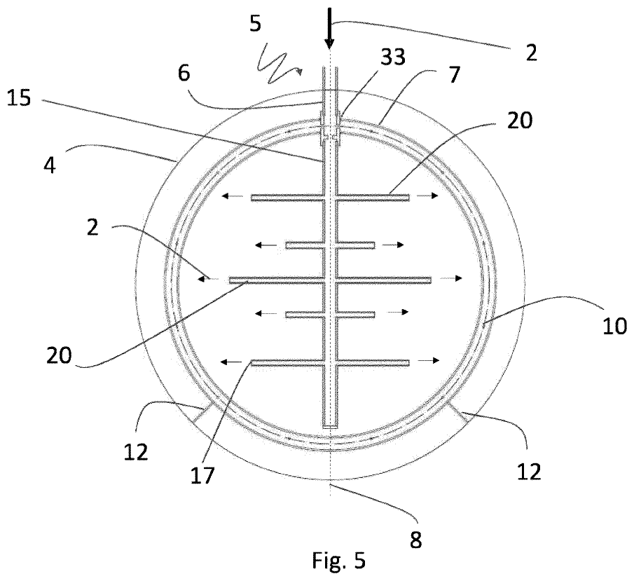

FIG. 5 shows a cross-sectional view of the injecting unit 5 according to an alternative embodiment of the invention.

The injection unit 5 comprises a main injection ring 7 and an injection conduct 15. The ammonia gas 2 is distributed between said ring 7 and conduct 15 by a distributor 33 similarly to FIG. 3.

The injection conduct 15 extends longitudinally from said manifold 6 and is provided with a plurality of injection tubes 20 that are disposed lengthwise forming at two rows along the length of said injection conduct 15. The rows are arranged on the opposite sides of the injection conduct 15.

The injection tubes 20 are parallel to each other and are arranged so that for each row of tubes, each pair of consecutive tubes is made of two tubes of different length.

Furthermore, each injection tube 20 is provided with an aperture 17 configured to eject the ammonia gas 2 with a flow direction perpendicular to the main longitudinal axis 16 of the distribution channel 4.

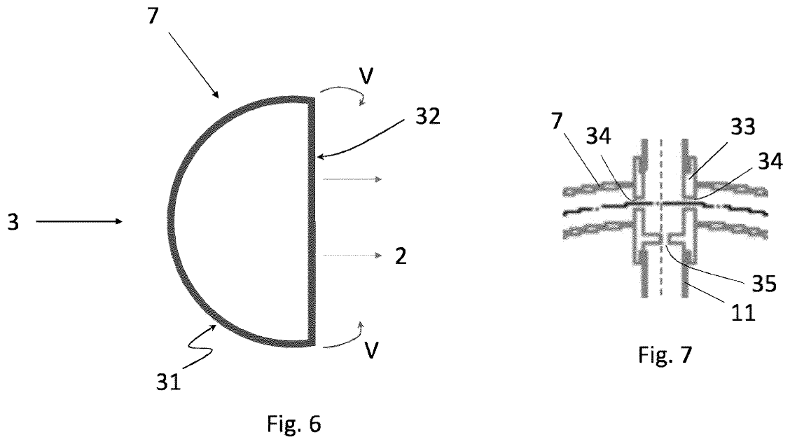

FIG. 6 illustrates an embodiment of injection ring 7 with a semicircular cross section. The cross section has a convex side 31 facing the direction of the mainstream gas 3 and a flat side 32 where the orifices 10 are arranged. The arrows V in FIG. 6 represent the formation of vortices around the edges of the semicircular ring, which improve mixing between the gas 3 and the ammonia 2. The embodiment of FIG. 6 may be equally applied to additional rings such as ring 9 of FIG. 3.

FIG. 7 illustrates the distributor 33 of the embodiment of FIG. 3. A similar distributor may be used in the embodiment of FIG. 7. The distributor 33 has one or more first passages 34 to feed ammonia gas to the main ring 7 and one or more second passages 35 to feed the ammonia gas to the additional ring 9. Said passages are preferably calibrated holes whose diameter is determined to achieve a target distribution of the incoming ammonia gas between the rings. The size of the passages 34, 35 in particular can be determined by taking into account the expected pressure loss in the rings, so that a desired flow rate of ammonia gas in each ring is ensured. For example, in the embodiment of FIG. 7 the distributor 33 has two lateral holes 34 feeding the main ring 7 on both sides and an axial hole 35 feeding the manifold 11 of the additional ring 9.

1-18. (canceled)

19. A nitric acid plant, comprising:
an absorption column; and
a conditioning system for removing nitrogen oxides (NOX) from an input gas by selective catalytic reduction;
wherein the conditioning system includes a catalytic reactor and a mixing system configured to mix a process gas into a mainstream, the catalytic reactor configured to catalytically reduce NOx contained in the input gas in presence a reducing agent, the mixing system configured so that the mainstream is the input gas directed to the catalytic reactor and the process gas is the reducing agent;
wherein the mixing system includes:
a distribution channel;
an injection unit;
a static mixing unit;
wherein:
the distribution channel has a main longitudinal axis which, in operation, determines the flow direction of the mainstream;
the injection unit includes a manifold and a main injection ring;
the manifold is arranged inside the distribution channel and is disposed perpendicularly to the main longitudinal axis of said distribution channel, said manifold is adapted to receive said process gas via said main injection ring; and
said main injection ring has a circular or annular structure and is provided with a plurality of injection orifices that are arranged to introduce said process gas into the mainstream;
wherein: in the absorption column, a NOx-containing gas is absorbed into water for production of nitric acid and a tail gas containing residual NOx is produced; said manifold of the mixing system is connected to a feed line of the reducing agent and said distribution channel (4) is connected to a tail gas output of said absorption column, so that the conditioning system is arranged to remove NOx from the tail gas of the absorption column.

20. The nitric acid plant according to claim 19, wherein said injection unit includes one or more additional rings that are arranged concentrically to said main injection ring and said one or more rings are in fluid communication with said manifold and with said main injection ring by one or more additional manifolds, said one or more additional manifolds are adapted to receive said process gas via said one or more additional rings, said one or more additional rings are provided with a plurality of injection orifice to introduce said process gas into the mainstream.

21. The nitric acid plant according to claim 19, wherein the plurality of injection orifices of at least one of the main injection ring and any additional ring of the one or more additional rings are oriented in the flow direction of the mainstream.

22. The nitric acid plant according to claim 19, wherein said main injection ring and said one or more additional rings lie in a plane that is perpendicular to said main longitudinal axis of said distribution channel and said main injection ring and said one or more additional rings are equally spaced between each other.

23. The nitric acid plant according to claim 19, wherein said main injection ring and/or said one or more additional rings are integral with said distribution channel by one or more supports.

24. The nitric acid plant according to claim 19, wherein the injection unit includes an injection tube, said injection tube extends longitudinally from said manifold and is provided with a plurality of metering openings disposed lengthwise along the length of said injection tube and said plurality of metering openings are oriented in the flow direction of the mainstream.

25. The nitric acid plant according to claim 19, wherein at least one of said main injection ring or any additional ring of the one or more additional rings has a non-circular cross section having a convex side facing the flow direction of the mainstream.

26. The nitric acid plant according to claim 25, wherein at least one of said main injection ring or any additional ring of the one or more additional rings has a semicircular cross section including a semicircular convex side facing the flow direction of the mainstream and a flat side wherein the injection orifices are arranged on the flat side.

27. The nitric acid plant according to claim 19, wherein said injection unit includes an injection conduct, said injection conduct extends longitudinally from said manifold and is provided with a plurality of injection tubes that are disposed lengthwise forming at least one row along the length of said injection conduct;
said plurality of injection tubes are parallel to each other and are arranged so that for each row of tubes, each pair of consecutive tubes is made of two tubes of different length;
each injection tube of the plurality of injection tubes is provided with an aperture configured to eject said process gas with a flow direction perpendicular to the main longitudinal axis of the distribution channel.

28. The nitric acid plant according to claim 27, wherein the number of rows is two and wherein the said two rows are arranged on the opposite sides of the injection conduct.

29. The nitric acid plant according to claim 19, wherein the number of injection orifices arranged on said main injecting ring is between 8 to 20.

30. The nitric acid plant according to claim 20, wherein the number of injection orifices arranged on each of said one or more additional rings is between 3 to 15.

31. The nitric acid plant according to claim 27, wherein the number of plurality of injection tubes arranged on said injection conduct is between 5 and 20.

32. The nitric acid plant according to claim 19, wherein said injection unit is symmetrical along an axis that is perpendicular to the main longitudinal axis of said distribution channel.

33. The nitric acid plant according to claim 19, wherein the injection unit includes said main injection ring and an injection conduct, said process gas distributed between said main injection ring and said injection conduct by a distributor; said distributor having one or more first passages to feed said process gas to the main injection ring and one or more second passages to feed said process gas to an additional ring, or to one or more additional manifolds, or to an injection tube; said one or more first passages and said one or more second passages being calibrated holes whose diameter is determined to achieve a target distribution of the incoming process gas between the main injection ring and said injection conduct or said oneadditional ring or said one or more additional manifolds or said injection tube.

34. The nitric acid plant according to claim 19, wherein the manifold is connected to an ammonia feed line, so that ammonia is used as reducing agent.

35. A mixing system configured to mix a process gas into a mainstream, the mixing system comprising:
a distribution channel;
an injection unit;
a static mixing unit;
wherein:
the distribution channel has a main longitudinal axis which, in operation, determines the flow direction of the mainstream;
the injection unit includes a manifold and a main injection ring;
the manifold is arranged inside the distribution channel and is disposed perpendicularly to the main longitudinal axis of said distribution channel, said manifold is adapted to receive said process gas via said main injection ring;
said main injection ring has a circular or annular structure and is provided with a plurality of injection orifices that are arranged to introduce said process gas into the mainstream;
wherein at least one of said main injection ring or any additional ring has a non-circular cross section having a convex side facing the flow direction of the mainstream; and
at least one of said main injection ring or any additional ring has a semicircular cross section including a semicircular convex side facing the flow direction of the mainstream and a flat side, wherein the injection orifices are arranged on the flat side.

36. A mixing system configured to mix a process gas into a mainstream, the mixing system comprising:
a distribution channel;
an injection unit;
a static mixing unit;
wherein:
the distribution channel has a main longitudinal axis which, in operation, determines the flow direction of the mainstream;
the injection unit includes a manifold and a main injection ring;
the manifold is arranged inside the distribution channel and is disposed perpendicularly to the main longitudinal axis of said distribution channel, said manifold is adapted to receive said process gas via said main injection ring;
said main injection ring has a circular or annular structure and is provided with a plurality of injection orifices that are arranged to introduce said process gas into the mainstream;
wherein said injection unit includes an injection conduct, said injection conduct extends longitudinally from said manifold and is provided with a plurality of injection tubes that are disposed lengthwise forming at least one row along the length of said injection conduct;
said injection tubes are parallel to each other and are arranged so that for each row of tubes, each pair of consecutive tubes is made of two tubes of different length;
each injection tube is provided with an aperture configured to eject said process gas with a flow direction perpendicular to the main longitudinal axis of the distribution channel;
wherein the number of rows is two and wherein the said two rows are arranged on the opposite sides of the injection conduct.
